(19) United States
(12) Patent Application Publication
(10) Pub. No.: US 2007/0097085 A1
(43) Pub. Date: May 3, 2007

(54) Data processing device

(76) Inventor: Kentaro Iwatsuki, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,901

(22) Filed: Oct. 27, 2005

(51) Int. Cl. G09G 5/00

(52) U.S. Cl. 345/173

(57) ABSTRACT

A display unit 10 consists of a CRT, a liquid crystal display unit or the like, and displays a virtual keyboard. A touch panel 12 is a touch panel formed from a nearly transparent material provided in front of the display unit 10. A control unit 14 displays a virtual keyboard on the display unit 10, and receives character input from a user, according to the position where the touch panel 12 has been touched and the display status of the display unit 10. When the user touches the touch panel 12, the control unit 14, identifies, from this touch position, the character corresponding to the touched position and the line to which this character belongs, and modifies the key array in such a way that the above input character display region is positioned immediately above the line to which the input key belongs, such that the movement of the user's line of sight becomes as small as possible.

### FIELD OF THE INVENTION

The present invention relates to an information processing device that allows for entering character input by way of a display panel provided with a touch panel.

### BACKGROUND INFORMATION

In recent years, technologies have been proposed for performing key input with a QWERTY array keyboard, by displaying the key display array either in the Japanese syllabary order, or by displaying this in Western alphabetical order.

In contrast to a computer keyboard a touch panel gives no feeling of protrusions and recesses, and the positions and sizes of each key are slightly different depending on the size of a touch panel display screen. Therefore, even for people who are used to computers, it is difficult to perform key input without looking at the keys. Thus, when performing key input, it is necessary to stare at the key, while at the same time verifying the input, by moving the line of sight to the input character display unit, which displays the entered character.

However, with the prior art, as the distance between the keys and the input character display unit is far, the movement of the line of sight is large, such that there is a problem in that the eyes become tired, easily leading to input mistakes. In particular, in the case of Roman character input, where alphabet is first entered and converted into Japanese kanji or hiragana scripts or the like, the line of sight moves a greater number of times than the number of characters that will actually be displayed, easily leading to eye fatigue and input mistakes.

The present invention was devised in consideration of the above, and an object thereof is to provide an information processing device allowing the movement of the line of sight to be decreased, and for eye fatigue and input mistakes to be alleviated.

### SUMMARY OF THE INVENTION

In order to solve the problems, the present invention is an information processing device provided with a display means for displaying a virtual keyboard having a predetermined array, and a touch panel type input means provided on the display surface of the display means, the information processing device comprising a touch character recognition means for identifying a character on the virtual keyboard corresponding to the position where the input means has been touched and the array line to which the character belongs, and a key array control means for modifying the key array of the virtual keyboard in such a way that an input character display region that displays the character is positioned immediately above the array line.

In addition, the present invention comprises a determination means for determining the user's hand dominance, the key array control means, based on the user's hand dominance as determined by the determination means, modifying the key array of the virtual keyboard so as to position the input character display region, which displays the character, immediately next to the array line.

In addition, the present invention comprises a display control means for displaying, in the vicinity of the position where the input means has been touched, the touched character with a character size that is at least larger than the character size of the keys displayed as the virtual keyboard.

According to this invention, the character on the virtual keyboard corresponding to the position where the input means has been touched, and the array line to which the character belongs are identified by the touch character recognition means, and the key array of the virtual keyboard is modified by the key array control means so as to position the input character display region, which displays the character, immediately above the array line. Therefore, an advantage is provided in that the distance between the touched key and the input character display region is decreased, allowing the movement of the line of sight to be decreased, and thereby reducing eye fatigue and input mistakes.

In addition, according to the present invention, the key array of the virtual keyboard is modified by the key array control means, based on the user's hand dominance as determined by the determination means, so as to position the input character display region, which displays the character, immediately next to the array line. Therefore, an advantage is provided in that the distance between the touched key and the input character display region is decreased, allowing the movement of the line of sight to be decreased, and thereby reducing eye fatigue and input mistakes.

In addition, according to the present invention, the touched character is displayed by the display control means, with a character size that is at least larger than the character size of the keys displayed as the virtual keyboard, in the vicinity of the position where the input means has been touched. Therefore, an advantage is provided in that the identity and the nature of the key that has been touched can easily be determined, and in that the distance between the touched key and the input character display region is decreased, allowing the movement of the line of sight to be decreased, and thereby reducing eye fatigue and input mistakes.

### BRIEF DESCRIPTION OF THE DRAWINGS

FIG. 1 is a schematic block diagram of a portion of the constitution of an information processing device according to a first embodiment.

FIG. 2 is a schematic view showing one example of virtual keyboard in the information processing device according to the first embodiment.

FIG. 3 is a flowchart for explaining a virtual keyboard display method of the information processing device according to the first embodiment.

FIG. 4 is a schematic view showing an example of a key array for explaining the virtual keyboard display method according to the first embodiment.

FIG. 5 is a schematic view showing an example of a key array for explaining the virtual keyboard display method according to the first embodiment.

FIG. 6 is a schematic view showing an example of a key array for explaining the virtual keyboard display method according to the first embodiment.

FIG. 7 is a flowchart for explaining a virtual keyboard display method of the information processing device according to a second embodiment.

FIG. 8 is a flowchart for explaining the virtual keyboard display method of the information processing device according to the second embodiment.

FIG. 9 is a schematic view showing an example of a key array for explaining a virtual keyboard display method according to the second embodiment.

FIG. 10 is a schematic view showing an example of a key array for explaining a virtual keyboard display method according to the second embodiment.

FIG. 11 is a schematic view showing an example of a key array for explaining the virtual keyboard display method in a variant.

### DETAILED DESCRIPTION OF THE PREFERRED EMBODIMENTS

Hereinafter, (a portion of) an information processing device according to one embodiment of the present invention will be described with reference to the figures.

### A. First Embodiment

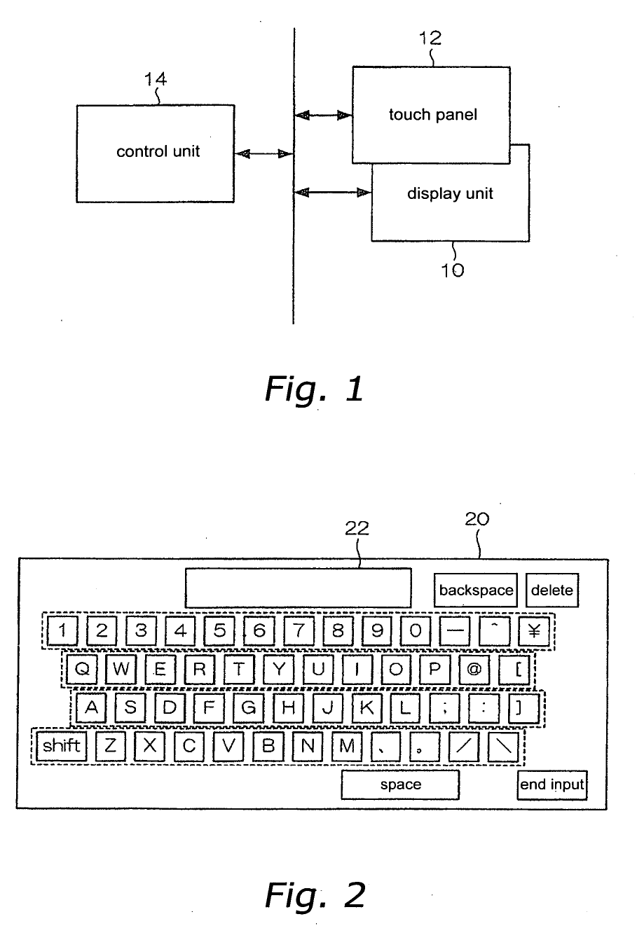

FIG. 1 is a schematic block diagram of a portion of the constitution of an information processing device according to the first embodiment.

A display unit 10 consists of a CRT, a liquid crystal display unit or the like, and in the first embodiment, it displays a virtual keyboard, described below. A touch panel 12 is a touch panel formed from a nearly transparent material provided in front of the display unit 10. A control unit 14 executes various data processing according to a predetermined control program. In particular, in the first embodiment, a virtual keyboard is displayed on the display unit 10, and character input from a user is received, according to the position where the touch panel 12 has been touched and the display status of the display unit 10.

Next, FIG. 2 is a schematic view showing one example of virtual keyboard in the information processing device according to the first embodiment.

In the figure, a virtual keyboard 20 is displayed on the display unit 10. The virtual keyboard 20 is displayed as a QWERTY array in the manner of a generic keyboard; however, the virtual keyboard 20 is not limited to, this and can be in the Japanese syllabary order or in Western alphabetical order. Keys that belong to the same line are established as one group, as indicated by the dotted line. For instance, “shift”, “Z”, “X”, and so forth, through “¥” belong to the first line, “A”, “S”, and so forth, through “]” belong to the second line, “Q”, “W”, and so forth, through “[” belong to the third line and “1”, “2”, and so forth, through “¥” belong to the fourth line. In addition, an input character display region 22 is a region where a character touch-entered by the user is displayed.

The user touches the desired character to be entered from the virtual keyboard 20 displayed on the display unit 10. At this moment, the control unit 14 identifies the character corresponding to the touched position and the array line to which this character belongs, and modifies the key array in such a way that the above input character display region 22 is positioned immediately above the line to which the input key belongs, such that the movement of the user's line of sight becomes as small as possible.

Next, the operation of the information processing device will be explained.

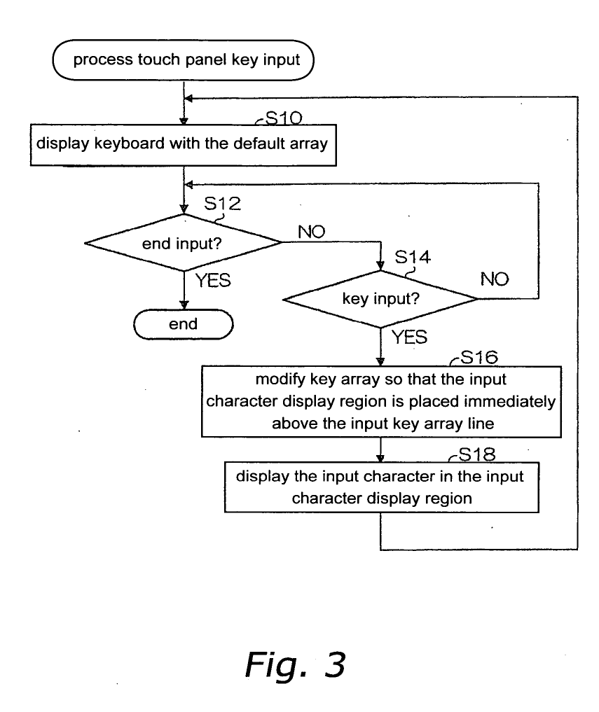

Here, FIG. 3 is a flowchart for explaining touch panel key input processing for the information processing device according to the first embodiment.

When key input is to be made by way of the virtual keyboard 20, the virtual keyboard 20 is first displayed on the display unit 10 with the default array shown in FIG. 2 (step S10). With this default array, the input character display region 22 is placed in the uppermost area. Next, whether or not there is an instruction to terminate key input from the virtual keyboard 20 (for instance, touching the “end input” key in FIG. 2) is assessed (step S12). Then, if there is an instruction to terminate the input, the process is terminated.

On the other hand, if there is no input termination, whether or not there is other key input (touch) is assessed (step S14). If there is not any key input, the process returns to step S12, and the above process is repeated. Conversely, if there is key input, the key array is modified in such a way that the input character display region 22 is placed immediately above the array line to which the entered (touched) key belongs (step S16), and the entered (touched) character is displayed in the input character display region 22 (step S18). Then, the process returns to step S10 displaying the virtual keyboard with the default array 20 such as shown in FIG. 2, and the above process is repeated thereafter.

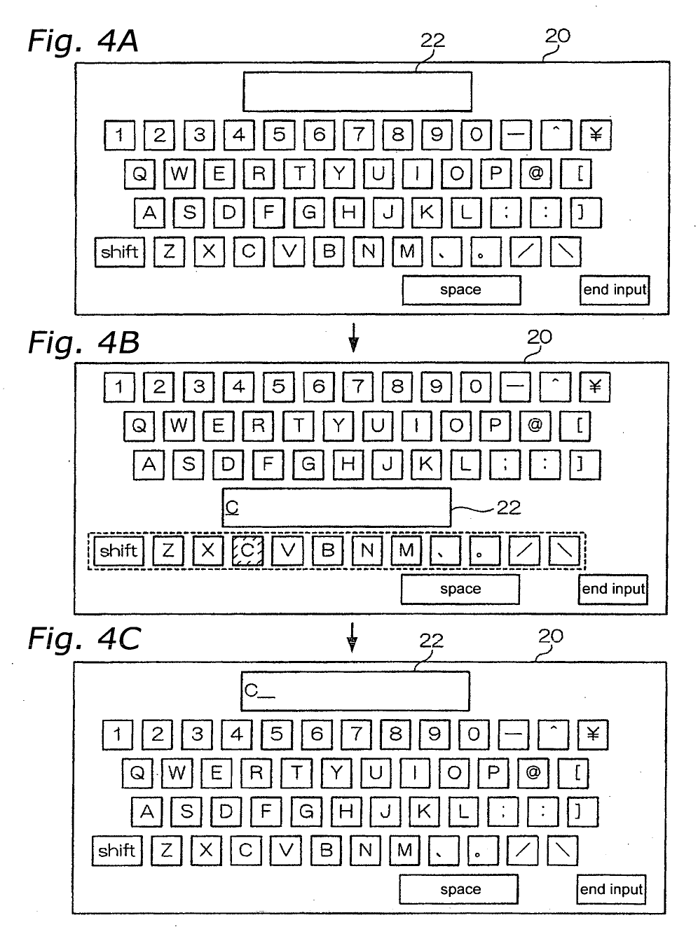

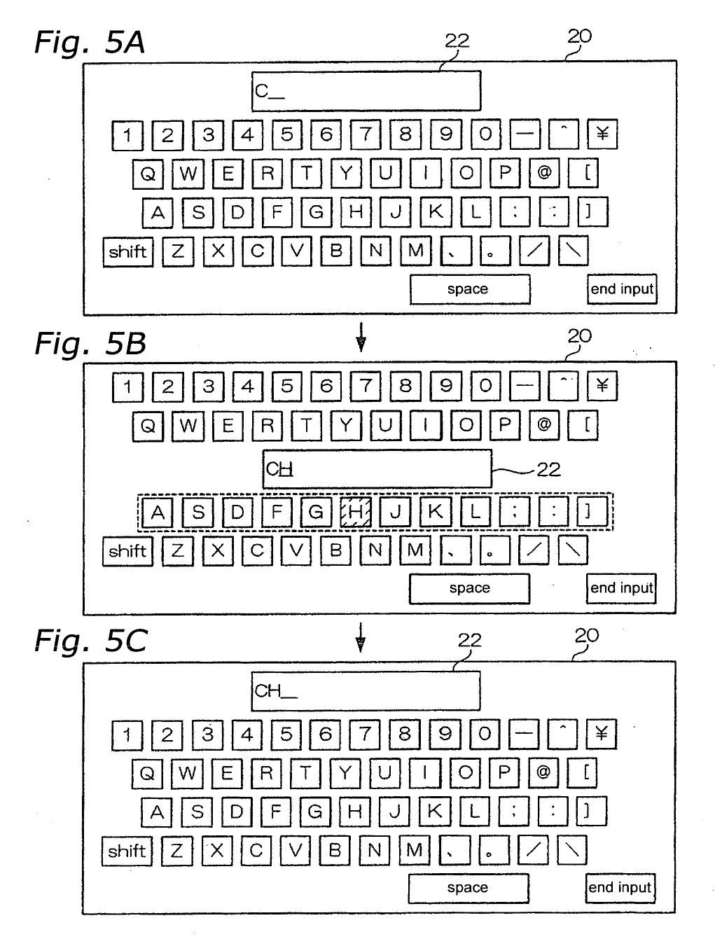

For instance, if, in the default array status as shown in FIG. 4 (a), a key on the first line indicated by a dotted line (“C” in the illustrated example) as shown in FIG. 4 (b) is touched, at this instant, the key array is modified so as to place the input character display region 22, immediately above the array line that has been touched. Thereafter, the process returns to the default array as shown in FIG. 4 (c). Similarly, if in the default array status as shown in FIG. 5 (a), a key on the second line indicated by a dotted line (“H” in the illustrated example) as shown in FIG. 5 (b) is touched, at this instant, the key array is modified so as to place the input character display region 22, immediately above the array line that has been touched. Thereafter, the process returns to the default array as shown in FIG. 5 (c).

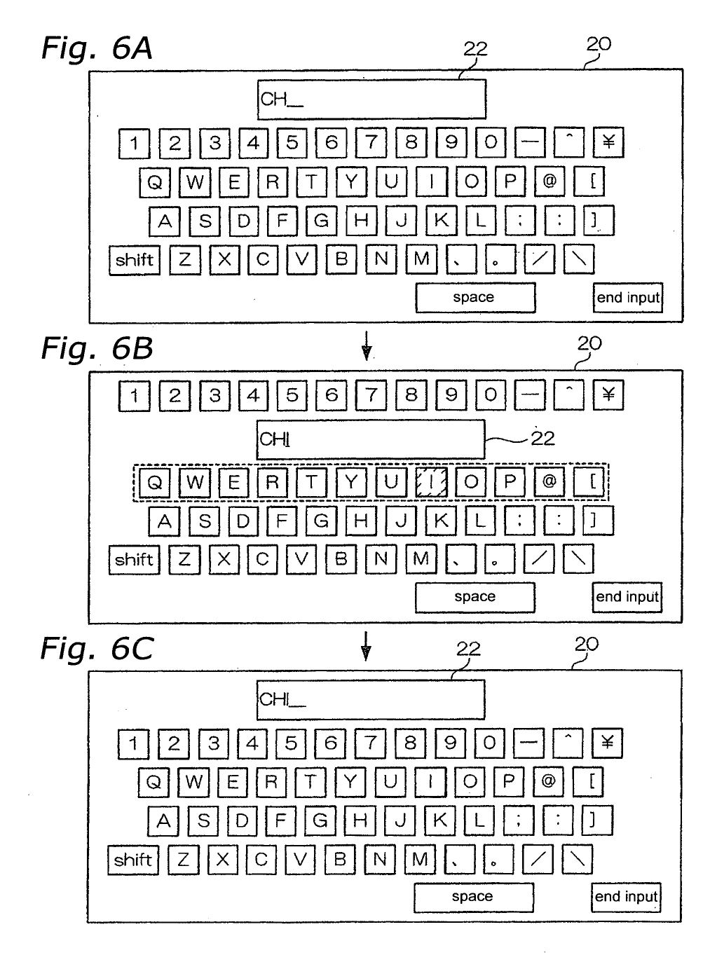

In addition, if in the default array status as shown in FIG. 6 (a), a key on the third line indicated by a dotted line (“I” in the illustrated example) as shown in FIG. 6 (b) is touched, at this instant, the key array is modified so as to place the input character display region 22, immediately above the array line that has been touched. Thereafter, the process returns to the default array as shown in FIG. 6 (c).

According to the first embodiment, as the key array is modified so as to place the input character display region 22 immediately above the key that has been touched by the user, the distance between the touched key and the input character display region 22 for verifying the input result thereof can be reduced, and as a result the movement of the user's line of sight can be decreased, allowing eye fatigue and input mistakes to be alleviated.

### B. Second Embodiment

Next, the second embodiment according to the present invention will be explained. In general, with a character input using a touch panel, the virtual keyboard is often smaller than keyboards on which one types using both hands. Therefore, the user may enter characters by touching with one hand, in particular, the dominant hand. Therefore, in the second embodiment, it is assumed that the user touches the keys with one hand, and by modifying the display configuration of the virtual keyboard that contains the input character display region, according to the user's hand dominance, the movement of the user's line of sight is decreased, so as to alleviate eye fatigue and input mistakes. Note that, as the constitution of the information processing device is identical to FIG. 1, description thereof will be omitted.

Next, the operation of the second embodiment will be explained.

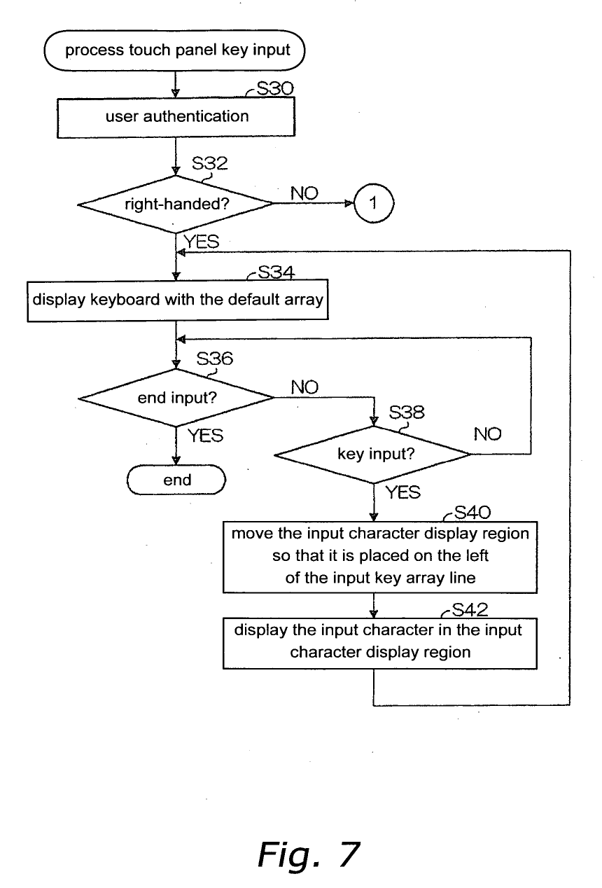

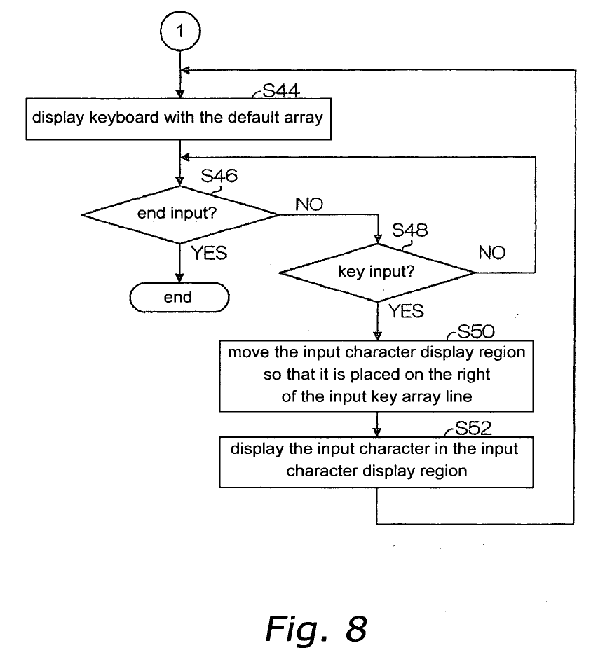

Here, FIG. 7 and FIG. 8 are flowcharts for explaining a virtual keyboard display method of the information processing device according to the second embodiment.

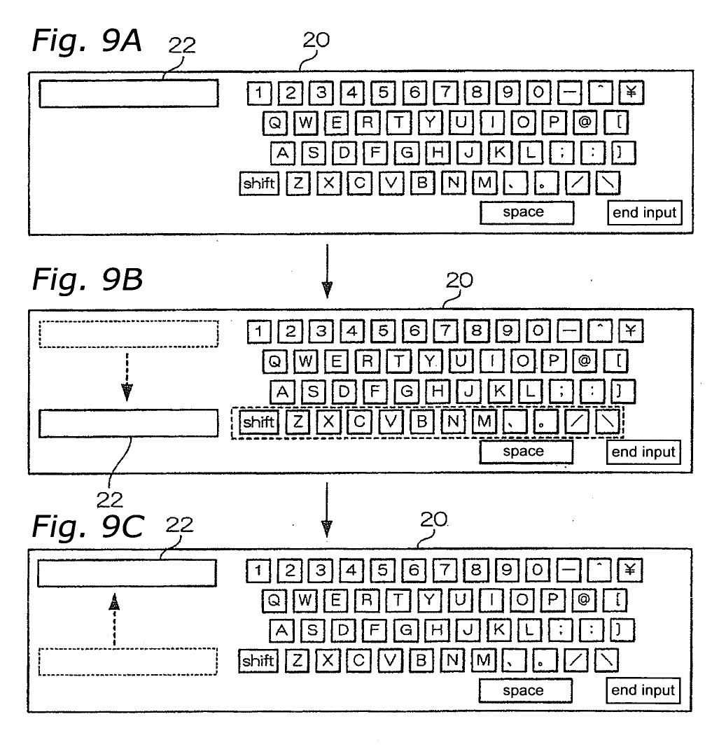

When a key input is made by way of the virtual keyboard 20, user authentication is first performed (step S30). Note that, user authentication may be performed when using the information processing device. In user authentication, individual information stored beforehand is referenced, so as to determine the user's hand dominance. Then, whether or not the user is right handed is assessed (step S32), and if the user is right handed, the virtual keyboard 20 is displayed on the display unit 10 with the default array shown in FIG. 9 (a) (step S30). In this default array, the input character display region 22 is displayed in the uppermost portion on the left side of the key array.

Next, whether or not there is an instruction to terminate key input from the virtual keyboard 20 is assessed (step S36). Then, if there is an instruction to terminate the input, the process is terminated. On the other hand, if input is not terminated, whether or not there is other key input (touch) is assessed (step S38). If there is not any key input, the process returns to step S36, and the above process is repeated.

In contrast, if there is key input, the key array is modified in such a way that the input character display region 22 is placed on the left, immediately next to the array line to which the entered (touched) key belongs (step S40), and the entered (touched) character is displayed in the input character display region 22 (step S42). For instance, if a key on the first line is touched, the input character display region 22 is moved on the left, immediately next to the first key array line, as shown in FIG. 9 (b). Then, the process returns to step S34, the virtual keyboard 20 is displayed with the default array as shown in FIG. 9 (a), and thereafter the above process is repeated.

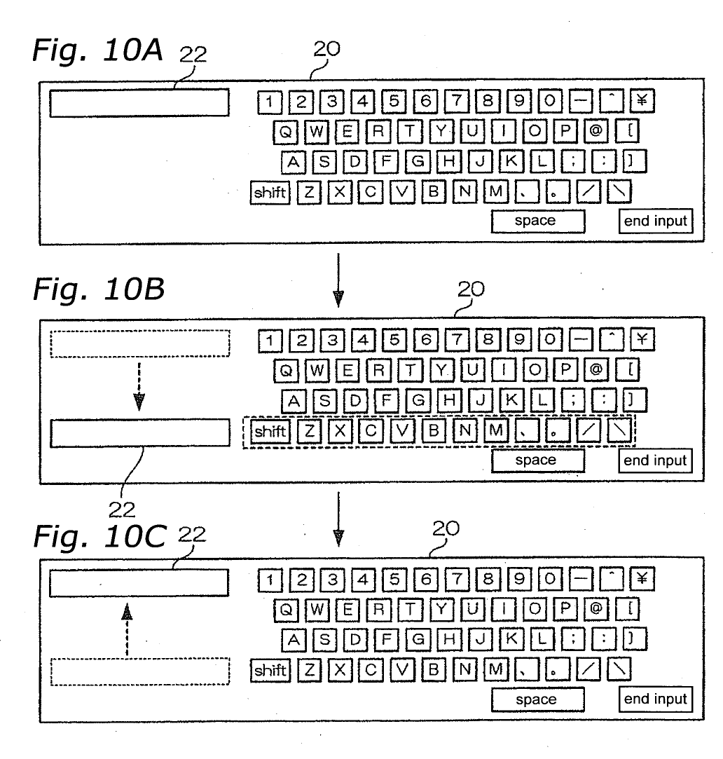

On the other hand, if the user is left handed, the virtual keyboard 20 is displayed on the display unit 10 with the default array shown in FIG. 10 (a) (step S44 in FIG. 8). In this default array, the input character display region 22 is displayed in the uppermost portion on the right side of the key array. Next, whether or not there is an instruction to terminate key input from the virtual keyboard 20 is assessed (step S46). Then, if there is an instruction to terminate the input, the process is terminated.

On the other hand, if input is not terminated, whether or not there is other key input (touch) is assessed (step S48). If there is not any key input, the process returns to step S46, and the above process is repeated. Conversely, if there is key input, the key array is modified in such a way that the input character display region 22 is placed on the right, immediately next to the array line to which the entered (touched) key belongs (step S50), and the entered (touched) character is displayed in the input character display region 22 (step S52). For instance, if a key on the first line is touched, the input character display region 22 is moved on the right, immediately next to the first key array line, as shown in FIG. 10 (b). Then, the process returns to step S34, the virtual keyboard 20 is displayed with the default array as shown in FIG. 9 (a), and thereafter the above process is repeated.

According to the second embodiment, as the display position of the input character display region is changed according to the user's hand dominance and the key array line touched by the user, the distance between the touched key and the input character display region 22 for verifying the input result thereof can be shortened, and as a result, the movement of the user's line of sight can be decreased, allowing eye fatigue and input mistakes to be alleviated.

### C. Variant

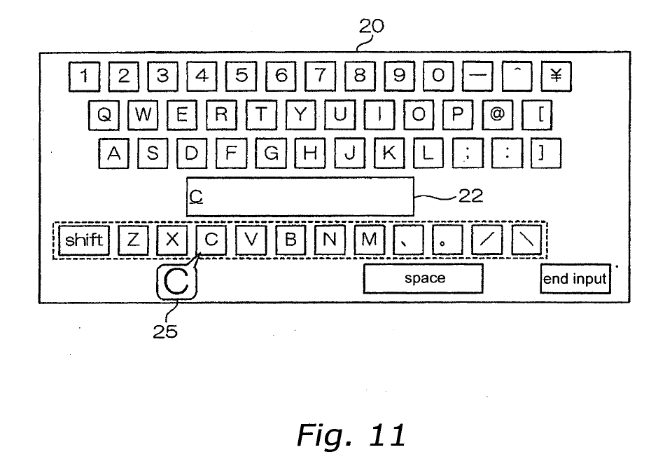

Next, as a variant of the present invention, when a key is touched, a “call-out” 25, for displaying as an enlargement the character that has been touched, may be displayed in vicinity of the touched key, as shown in FIG. 11. In this way, the user can easily determine what the touched key is and which key has been touched. As a result, eye fatigue and input mistakes can be further alleviated. This variant can be applied to both the first embodiment and the second embodiment.

Note that the control unit 14 is constituted by a memory and a CPU (central processing unit) or the like, and a program (not shown) for realizing the above processes in the control unit 14 is loaded from a nonvolatile memory, a magnetic disk or the like, in which it is stored, into the memory and executed so as to realize the function.

What is claimed is:

1. An information processing device provided with a display means for displaying a virtual keyboard having a predetermined array, and a touch panel type input means provided on the display surface of the display means, the information device comprising:
a touch character recognition means for identifying a character on the virtual keyboard corresponding to the position where the input means has been touched and the array line to which the character belongs; and
a key array control means for modifying the key array of the virtual keyboard in such a way that an input character display region that displays the character is positioned immediately above the array line.

2. The information processing device of claim 1 comprising a determination means for determining the user's hand dominance, wherein
based on the user's hand dominance as determined by the determination means, the key array control means modifies the key array of the virtual keyboard so as to position the input character display region, which displays the character, immediately next to the array line

3. The information processing device of claim 1 comprising a display control means for displaying, in the vicinity of the position where the input means has been touched, the touched character with a character size that is at least larger than the character size of the keys displayed as the virtual keyboard.
